(19) United States
(12) Patent Application Publication
(10) Pub. No.: US 2025/0053434 A1
(43) Pub. Date: Feb. 13, 2025

(54) AGENT STATE MANAGEMENT FOR VIRTUAL COMPUTING INSTANCES

(71) Applicant: VMWARE, LLC., Palo Alto, CA (US)

(72) Inventors: RUSHIT NILAY DESAI, Pune (IN); Nakul Ranjan Ogale, Karvenagar (IN); Umesh Prakash Mankapure, Pune (IN)

(21) Appl. No.: 18/379,201

(22) Filed: Oct. 12, 2023

(30) Foreign Application Priority Data
Aug. 7, 2023 (IN) 202341052918

(51) Int. Cl. G06F 9/455

(52) U.S. Cl. CPC G06F 9/45558; G06F 2009/45562; G06F 2009/45591; G06F 2009/45595

(57) ABSTRACT

A management node may include a storage device to store mapping information associating an identifier of a virtual computing instance deployed in a data center with an identifier of an agent that runs in the virtual computing instance. Further, the management node may an agent management module to receive an event notification indicating a state change of the virtual computing instance from an infrastructure management component residing in the data center. The event notification may include the identifier of the virtual computing instance. In response to receiving the event notification, the agent management module may determine the agent that is likely to affect due to the state change of the virtual computing instance based on mapping information and the identifier of the virtual computing instance. Further, the agent management module may manage a state of the agent based on the state change of the virtual computing instance.

### RELATED APPLICATIONS

Benefit is claimed under 35 U.S.C. 119 (a)-(d) to Foreign Application Serial No. 202341052918 filed in India entitled “AGENT STATE MANAGEMENT FOR VIRTUAL COMPUTING INSTANCES”, on Aug. 7, 2023, by VMware, Inc., which is herein incorporated in its entirety by reference for all purposes.

### TECHNICAL FIELD

The present disclosure relates to computing environments, and more particularly to methods, techniques, and systems for managing a state of an agent based on a state change of a virtual computing instance in the computing environments.

### BACKGROUND

In computing environments, such as networked computing environments, cloud computing environments, virtualized environments, and the like, different applications may be executed on endpoints. An example endpoint may be a physical computer system, a virtual computing instance, or the like. In an example virtualized environment, multiple physical computer systems (e.g., host computing systems) may execute different virtual computing instances such as virtual machines, containers, and the like running therein. Computer virtualization may be a technique that involves encapsulating a representation of a physical computing machine platform into a virtual machine that may be executed under the control of virtualization software running on hardware computing platforms. The hardware computing platforms may also be referred to as the host computing systems or servers. A virtual machine can be a software-based abstraction of the physical computer system. Each virtual machine may be configured to execute an operating system (OS), referred to as a guest OS, and applications. A container may be a data computer node that runs on top of a host OS without the need for a hypervisor or separate OS.

In such computing environments, an agent may be installed in a virtual computing instance to monitor the virtual computing instance and send monitored data to a monitoring server for analysis. An example of the agent may be Telegraf™, an open-source tool that runs on the virtual computing instance, collects metrics (e.g., application metrics, operating system metrics, and the like), and transmit the performance metrics to a monitoring tool or a monitoring application for metric analysis. In another example, some cloud based anti-virus solutions may include a cloud agent running on the virtual computing instance and sends events to a cloud security monitoring service, which may be a cloud backend service. The cloud security monitoring service decides whether to allow or deny a network connection and publishes appropriate security policies and rules to the cloud agent, which the cloud agent enforces on the virtual computing instance.

### BRIEF DESCRIPTION OF THE DRAWINGS

FIG. 1 is a block diagram of an example computing environment, including an agent management module to manage a state of an agent based on a state change of a virtual computing instance;

FIG. 2 is a block diagram of an example computing system, including an agent management module to manage a state of an agent for a virtual computing instance;

FIG. 3 is an example sequence diagram illustrating a sequence of events to manage a state of an agent based on a state change of a virtual computing instance;

FIG. 4 is a flow diagram illustrating an example method for managing a state of an agent based on a state change of a virtual computing instance; and

FIG. 5 is a block diagram of an example management node including non-transitory computer-readable storage medium storing instructions to manage a state of an agent based on a state change of a virtual computing instance.

The drawings described herein are for illustrative purposes and are not intended to limit the scope of the present subject matter in any way.

### DETAILED DESCRIPTION

Examples described herein may provide an enhanced computer-based and/or network-based method, technique, and system to manage a state of an agent based on a state change of a virtual computing instance in a computing environment. The paragraphs [0011] to [0019] present an overview of the computing environment, existing methods to manage the state of the agent associated with the virtual computing instance in the computing environment, and drawbacks associated with the existing methods.

Computing environment may be a physical computing environment (e.g., an on-premises enterprise computing environment or a physical data center) and/or virtual computing environment (e.g., a cloud computing environment, a virtualized environment, and the like). The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in virtual space being hosted by one or more physical data centers. Example virtual computing environment may include different endpoints (e.g., physical computers, virtual machines, and/or containers). For example, the computing environment may include multiple application hosts (i.e., physical computers) executing different virtual computing instances (e.g., referred to as workloads) such as virtual machines, containers, and the like running therein. Example endpoints may execute different types of applications.

Further, monitoring of the virtual computing instances has become increasingly important because monitoring may aid in troubleshooting (e.g., to rectify abnormalities or shortcomings, if any) the virtual computing instances, provide better health of data centers, analyse the cost, capacity, and/or the like. An example performance monitoring tool or application or platform may be VMware® vRealize Operations (vROps), VMware Wavefront™, Grafana, and the like. Such performance monitoring tools may be used to monitor the data centre on a private, public, and/or hybrid cloud. In some examples, the virtual computing instances may include monitoring agents (e.g., Telegraf™, Collectd, Micrometer, and the like) to collect the performance metrics from the respective virtual computing instances and provide, via a network, the collected performance metrics to the performance monitoring tool.

In another example, cloud based anti-virus solutions may include a security agent running on the virtual computing instances and sending events to a cloud security monitoring service, which may be a cloud backend service. The cloud security monitoring service decides whether to allow or deny a network connection and publishes appropriate security policies and rules to the security agent, which the security agent enforces on the endpoint. Similarly, the virtual computing instance may include different types of agents to perform different monitoring functions/activities corresponding to the virtual computing instance.

In an enterprise infrastructure setup, a significantly large number of virtual computing instances running in the infrastructure may cater to different business needs. Further, to monitor such an infrastructure, multiple agents may be deployed on the virtual computing instances. Furthermore, the infrastructure may be communicatively connected to a management node or monitoring server to analyze the monitored information collected by the agents. Further, the state of an agent installed on the virtual computing instances may be monitored via the management node. For example, the agent's state may be shown as running/active while they are deployed and running on the virtual computing instances.

In some examples, the virtual computing instances on which the agents are deployed may be terminated, deleted, or removed from the data center at any given time and this may happen frequently considering the virtual computing instances nature and usage. When these virtual computing instances are terminated, deleted, or removed from the data center, the agents deployed on these virtual computing instances may not identify when the terminate/delete/remove operation happens. Thus, the agents deployed on the virtual computing instances may not be able to update their state and they may be still showing as running/active on the management node. This creates an incorrect representation of the agent's state on the management node. Hence, users of the management node may receive invalid and incomplete data of agents' state, which may cause business issues.

For example, consider a business-critical agent such as a security agent that is deployed on a virtual computing instance. Also, consider that the virtual computing instance is powered down for a duration longer than the user configured inactive time interval in the management node. The same virtual computing instance when powered-on, the virtual computing instance may not be able to execute the agent's intended functions since the agent would be marked as inactive/deregistered (e.g., inferred based on time interval) by the management node. This may impact the security or business function posture of the organization.

In another example, when the agents have licenses attached to its usage and when the management node continues to report active status for agents whose virtual computing instances are deleted/terminated, then the organization may be required to pay for a significantly higher number of licenses than required.

In some existing methods, a ‘heartbeat’ mechanism is established from the agents deployed to their management node. In this example, each agent may send a message which notifies the management node that the agent is active. Further, on the management node, the users can configure a time interval (e.g., known as ‘inactive interval’). When an agent fails to send a ‘heartbeat’ message in the specified ‘inactive interval’, then the agent may be marked as terminated/deleted/removed.

However, the existing methods fail to distinguish between a virtual computing instance being terminated/deleted/removed or the virtual computing instance is being powered-off. In both cases, the agent may stop sending the ‘heartbeat’ message to the management node. Hence, after the ‘inactive internal’, the management node may update the state of the agent incorrectly. Also, since the existing methods rely on defining an ‘inactive interval’, the behaviour may turn out differently for different agents or enterprises based on how they want to interpret when the agent state has to be updated. This may lead to inconsistent definitions of updating agent state across the agents and the enterprises.

Examples described herein may provide a management node including an agent management module to manage an agent state for virtual computing instances. The agent management module may receive from an agent running in a virtual computing instance, monitored data of the virtual computing instance deployed in a data center. The monitored data may include an identifier of the virtual computing instance. Further, the agent management module may generate mapping information that associates the identifier of the virtual computing instance with an identifier of the agent. Furthermore, the agent management module may receive an event notification indicating a state change of the virtual computing instance from an infrastructure management component residing in the data center. In response to receiving the event notification, the agent management module may identify the agent that is affected due to the state change of the virtual computing instance based on the mapping information and manage a state of the agent based on the state change of the virtual computing instance. Thus, examples described herein may accurately identify the state of the agent, which is being used and active, inactive, or the like.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

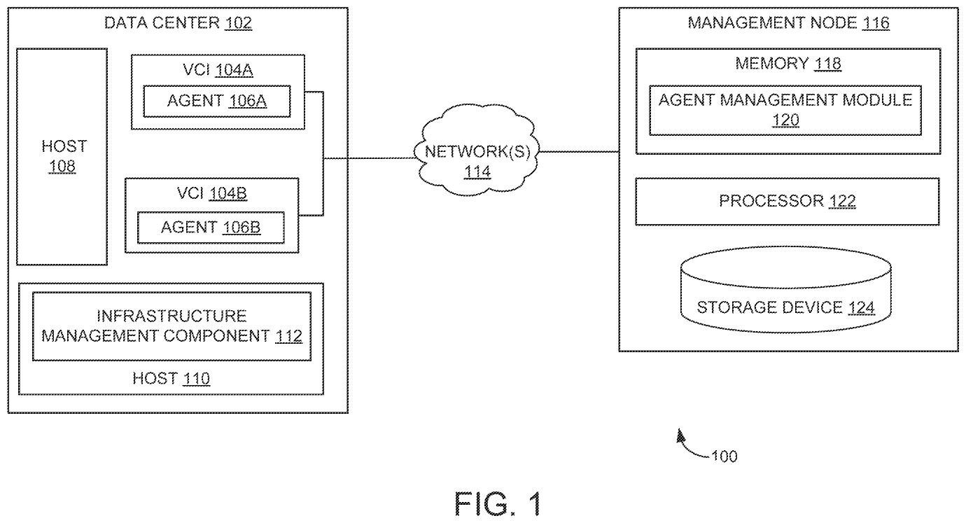

Referring now to the figures, FIG. 1 is a block diagram of an example computing environment 100, including an agent management module 120 to manage a state of an agent (e.g., 106A) based on a state change of a virtual computing instance (e.g., 104A). Example computing environment 100 may be a cloud computing environment (e.g., a virtualized cloud computing environment), a physical computing environment, or a combination thereof. For example, the cloud computing environment may be enabled by vSphere®, VMware's cloud computing virtualization platform. The cloud computing environment may include one or more computing platforms that support the creation, deployment, and management of virtual machine-based cloud applications or services or programs. An application, also referred to as an application program, may be a computer software package that performs a specific function directly for an end user or, in some cases, for another application. Examples of applications may include MySQL, Tomcat, Apache, word processors, database programs, web browsers, development tools, image editors, communication platforms, and the like.

Example computing environment 100 may include a data center 102 having multiple host computing systems (e.g., a host 108), each executing corresponding ones of virtual computing instances (VCIs) or workloads 104A and 104B. In an example, the virtual computing instance (e.g., 104A and 104B) may be a virtual machine (VM) executing on host 108 in data center 102. In this example, host 108 may be a physical computer. In another example, the virtual computing instance (e.g., 104A and 104B) may be a container executing on host 108 in data center 102. In this example, host 108 may be a virtual machine or a physical computer. The physical computer may be a hardware-based device (e.g., a personal computer, a laptop, or the like) including an operating system (OS). A virtual machine may operate with its own guest OS on the physical computer using resources of the physical computer virtualized by virtualization software (e.g., a hypervisor, a virtual machine monitor, and the like). A container may be a data computer node that runs on top of a host operating system without the need for the hypervisor or separate operating system.

Further, each of virtual computing instances 104A and 104B may include an agent (e.g., 106A and 106B) to monitor applications, services, and/or programs running in respective virtual computing instances 104A and 104B. In an example, agents 106A and 106B may be installed in respective virtual computing instances 104A and 104B to fetch metrics from various components of virtual computing instances 104A and 104B. For example, agents 106A and 106B may real-time monitor respective virtual computing instances 104A and 104B to collect the metrics (e.g., telemetry data) associated with an application or an operating system running in virtual computing instances 104A and 104B. In this example, agent 106A and 106B may be Telegraf agent, Collectd agent, or the like. Example metrics may include performance metric values associated with at least one of central processing unit (CPU), memory, storage, graphics, network traffic, applications, or the like. In another example, agent 106A and 106B may be a security agent running on the virtual computing instances to monitor and send monitored events to a cloud security monitoring service in cloud based anti-virus solutions.

Furthermore, agents 106A and 106B may publish the metrics (e.g., heartbeat messages, signals, and the like) via a network 114 to a management node 116 for analyzing the metrics. Example network 114 can be a managed Internet protocol (IP) network administered by a service provider. For example, network 114 may be implemented using wireless protocols and technologies, such as WiFi, WiMax, and the like. In other examples, network 114 can also be a packet-switched network such as a local area network, wide area network, metropolitan area network, Internet network, or other similar type of network environment. In yet other examples, network 114 may be a fixed wireless network, a wireless local area network (LAN), a wireless wide area network (WAN), a personal area network (PAN), a virtual private network (VPN), intranet or other suitable network system and includes equipment for receiving and transmitting signals.

Further, data center 102 may include a host 110 executing an infrastructure management component 112. For example, host 110 may be a virtual machine or a physical computer. The functionalities described in FIG. 1, in relation to instructions to implement functions of infrastructure management component 112 may be implemented as engines or modules including any combination of hardware and programming to implement the functionalities of the modules or engines described herein. The functions of infrastructure management component 112 may also be implemented by a processor. In examples described herein, the processor may include, for example, one processor or multiple processors included in a single device or distributed across multiple devices.

During operation, infrastructure management component 112 may be operable to detect a state change of the virtual computing instance (e.g., 104A) and generate an event notification indicating the state change of virtual computing instance 104A. In an example, the event notification may include the identifiers of virtual computing instances 104A. Further, infrastructure management component 112 may communicate the event notification to one or more subscribers using a publish-subscribe mechanism.

As shown in FIG. 1, computing environment 100 may include a management node 116. In an example, management node 116 may include a storage device 124 to store mapping information associating an identifier of a virtual computing instance (e.g., 104A) deployed in data center 102 with an identifier of an agent (e.g., 106A) that runs in the virtual computing instance (e.g., 104A). Further, management node 116 may include a processor 122 communicatively coupled to storage device 124. Processor 122 may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 122 may, for example, include single or multiple cores on a chip, multiple cores across multiple chips, multiple cores across multiple devices, or suitable combinations thereof. Processor 122 may be functional to fetch, decode, and execute instructions as described herein.

Further, management node 116 includes memory 118 coupled to processor 122. Memory 118 may include agent management module 120. Furthermore, processor 122 may execute agent management module 120 stored in memory 118. During operation, agent management module 120 may receive monitored data of virtual computing instance 104A deployed in data center 102 from agent 106A running in virtual computing instance 104A. For example, the monitored data may include the identifier of virtual computing instance 104A. Further, agent management module 120 may generate mapping information that associates the identifier of virtual computing instance 104A with the identifier of agent 106A. Furthermore, agent management module 120 may store the mapping information in storage device 124.

Further, agent management module 120 may receive an event notification indicating the state change of virtual computing instance 104A from infrastructure management component 112 residing in data center 102. The event notification may include the identifier of virtual computing instance 104A. For example, the state change of a virtual computing instance may include a change in state for the virtual computing instance from a powered-off state to a powered-on state, from a powered-on state to a powered-off state, or the virtual computing instance being deleted/terminated from data center 102. In an example, agent management module 120 may receive the event notification from infrastructure management component 112 using the publish-subscribe mechanism. The publish-subscribe mechanism may enable infrastructure management component 112 to publish the event notification indicating the state change and enable agent management module 120 to subscribe to the event notification published by infrastructure management component 112.

In response to receiving the event notification, agent management module 120 may determine agent 106A that is likely to affect due to the state change of virtual computing instance 104A based on mapping information and the identifier of virtual computing instance 104A. In this example, agent management module 120 may retrieve the mapping information from storage device 124 using the identifier of virtual computing instance 104A and then determine agent 106A that is mapped to virtual computing instance 104A using the retrieved mapping information. Further, agent management module 120 may manage a state of agent 106A based on the state change of virtual computing instance 104A.

In an example, agent management module 120 may determine whether virtual computing instance 104A is powered-off, powered-on, or deleted/terminated from data center 102 based on the event notification. When the state change indicates that virtual computing instance 104A is powered-off, agent management module 120 may determine a cause of a failure to receive monitored data from agent 106A is due to virtual computing instance 104A being powered-off in data center 102. Further, agent management module 120 may update the state of agent 106A to indicate that virtual computing instance 104A is powered-off. In this example, the state of agent 106A is updated to disable monitoring of virtual computing instance 104A, until a power-on state of virtual computing instance 104A is detected.

When the state change indicates that virtual computing instance 104A is deleted, agent management module 120 may determine a cause of a failure to receive monitored data from agent 106A is due to virtual computing instance 104A being deleted from data center 102. Further, agent management module 120 may update the state of the agent to indicate that virtual computing instance 104A is deleted. In this example, the state of agent 106A is updated to disable monitoring of virtual computing instance 104A.

In response to determining that virtual computing instance 104A is powered-on, agent management module 120 may determine that the monitored data received from agent 106A is due to virtual computing instance 104A being powered-on in data center. Further, agent management module 120 may update the state of agent 106A to indicate that virtual computing instance 104A is active. In this example, the state of agent 106A is updated to enable monitoring of virtual computing instance 104A.

In some examples, the functionalities described in FIG. 1, in relation to instructions to implement functions of agent management module 120 and any additional instructions described herein in relation to the storage medium, may be implemented as engines or modules including any combination of hardware and programming to implement the functionalities of the modules or engines described herein. The functions of agent management module 120 may also be implemented by respective processors. In examples described herein, each processor may include, for example, one processor or multiple processors included in a single device or distributed across multiple devices.

Further, the cloud computing environment illustrated in FIG. 1 is shown purely for purposes of illustration and is not intended to be in any way inclusive or limiting to the embodiments that are described herein. For example, a typical cloud computing environment would include many more virtual computing instances, which may be distributed over multiple hosts and data centers, which might include many other types of devices, such as switches, power supplies, cooling systems, environmental controls, and the like, which are not illustrated herein. It will be apparent to one of ordinary skill in the art that the example shown in FIG. 1 as well as all other figures in this disclosure have been simplified for ease of understanding and are not intended to be exhaustive or limiting to the scope of the idea.

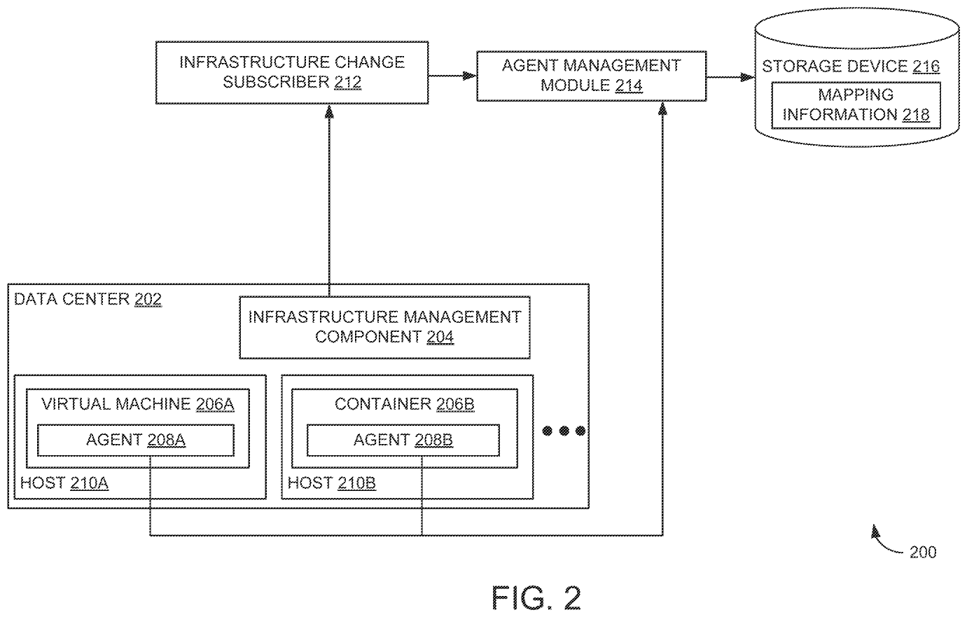

FIG. 2 is a block diagram of an example computing system 200, including an agent management module 214 to manage a state of an agent (e.g., 208A or 208B) for a virtual computing instance (e.g., 206A or 206B, respectively). Example computing system 200 may include a data center 202 having multiple hosts 210A and 210B. Further, each of hosts 210A and 210B may execute corresponding virtual computing instances such as a virtual machine 206A and a container 206B, respectively. Further, data center 202 may include an infrastructure management component 204 (e.g., infrastructure management component 112 of FIG. 1) to generate an event notification indicating a state change of virtual machine 206A, container 206B, or both.

As shown in FIG. 2, computing system 200 may include an infrastructure change subscriber 212 that is subscribed to the event notification from infrastructure management component 204. Further, infrastructure change subscriber 212 may receive the event notification and communicate the event notification to an agent management module 214. In an example, infrastructure change subscriber 212 and agent management module 214 can be implemented as part of a same compute node (e.g., management node 116 of FIG. 1). In another example, infrastructure change subscriber 212 and agent management module 214 can be implemented in different compute nodes that are communicatively connected to each other.

Further, computing system 200 may include a storage device 216 to store mapping information 218. For example, mapping information 218 may associate an identifier (e.g., a unique identifier) of virtual machine 206A and container 206B with an identifier (e.g., a unique identifier) of corresponding agents 208A and 208B that runs in virtual machine 206A and container 206B, respectively.

For example, upon installation of agent 208A, while reporting monitored data to agent management module 214, agent 208A may send the identifier of virtual machine 206A (e.g., a unique identifier across all virtual machines in that provider space). The identifier may be a single identifier such as virtual machine's 206A universally unique identifier (uuid) or a combination of identifiers such as virtual machine's 206A identifier along with host's 210A identifier on which virtual machine 206A is deployed. This identifier may be in addition to the unique identifier that agent 208A sends to agent management module 214, which may be unique for agent's 208A space in agent management module 214.

At agent management module 214, when agent management module 214 gets the unique identifier information from agent 208A, agent management module 214 may generate mapping information 218 based on a mapping between the unique identifier of agent 208A and the unique identifier of virtual machine 206A received from agent 208A and store mapping information 218 in storage device 216.

Furthermore, infrastructure management component 204 may detect any state changes happening in virtual machine 206A or container 206B. In an example, infrastructure management component 204 may record an event such as powering-off, powering-on, or deletion of virtual machine 206A and send the event information to subscribers (e.g., an infrastructure change subscriber 212) outside of data center 202. For example, infrastructure change subscriber 212 may listen to any changes in virtual machine 206A or container 206B via infrastructure management component 204 and provide the information to agent management module 214. In an example, infrastructure change subscriber 212 may communicate to agent management module 214 via an application programming interface (API), messaging channels, or the like.

For example, when any state change in virtual machine 206A is detected, agent management module 214 may be notified of the same via infrastructure change subscriber 212. Further, using the notification, agent management module 214 may take appropriate action on agent's 208A state.

In an example, when virtual machine 206A is powered-off, agent management module 214 may be notified that the state of virtual machine 206A is powered-off. Hence, even when heartbeat/signals from agent 208A stops at agent management module 214, agent management module 214 may be able to detect that the cause of agent's 208A heartbeat stoppage is due to powered-off state of virtual machine 206A and agent 208A would be running again when virtual machine 206A is powered-on.

In another example, when virtual machine 206A is terminated/deleted from data center 202, then infrastructure change subscriber 212 may receive an event indicating termination of virtual machine 206A. In this example, agent management module 214 may be able to correctly identify that virtual machine 206A is deleted/terminated forever and hence mark agent's 208A state appropriately.

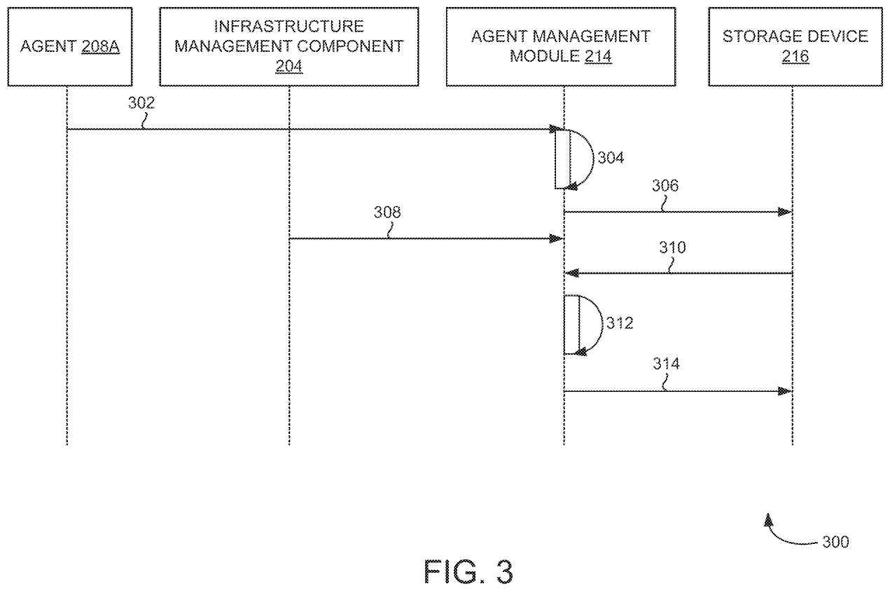

FIG. 3 is an example sequence diagram 300 illustrating a sequence of events to manage a state of an agent (e.g., agent 208A) based on a state change of a virtual computing instance (e.g., virtual computing instance 206A of FIG. 2). For example, similarly named elements of FIG. 3 may be similar in structure and/or function to elements described with respect to FIG. 2. Sequence diagram 300 may represent the interactions and the operations involved in managing the state of agent 208A. FIG. 3 illustrates process objects including agent 208A, infrastructure management component 204, agent management module 214, and storage device 216 along with their respective vertical lines originating from them. The vertical lines of agent 208A, infrastructure management component 204, agent management module 214, and storage device 216 may represent the processes that may exist simultaneously. The horizontal arrows (e.g., 302, 306, 308, 310, and 314) may represent the data flow steps between the vertical lines originating from their respective process objects (for e.g., agent 208A, infrastructure management component 204, agent management module 214, and storage device 216). Further, activation boxes (e.g., 304 and 312) between the horizontal arrows may represent the process that is being performed in the respective process object.

At 302, agent management module 214 may receive monitored data of a virtual computing instance from agent 208A running in the virtual computing instance. The monitored data may include an identifier of the virtual computing instance. Upon receiving the identifier, at 304, agent management module 214 may generate mapping information that associates the identifier of the virtual computing instance with an identifier of agent 208A. In some examples, the mapping information may be generated when the agent sends the monitored data for the first time after being installed on the virtual computing instance or after the virtual computing instance being migrated to a different host. Further, at 306, agent management module 214 may store the mapping information in storage device 216.

At 308, agent management module 214 may receive an event notification indicating a state change of the virtual computing instance from infrastructure management component 204. Upon receiving the event notification, agent management module 214 may retrieve the mapping information from storage device 216, at 310.

At 312, agent management module 214 may identify agent 208A that is affected due to the state change of the virtual computing instance based on the mapping information and the event notification. Further, at 314, agent management module 214 may update a state of agent 208A in storage device 216 based on the state change of the virtual computing instance.

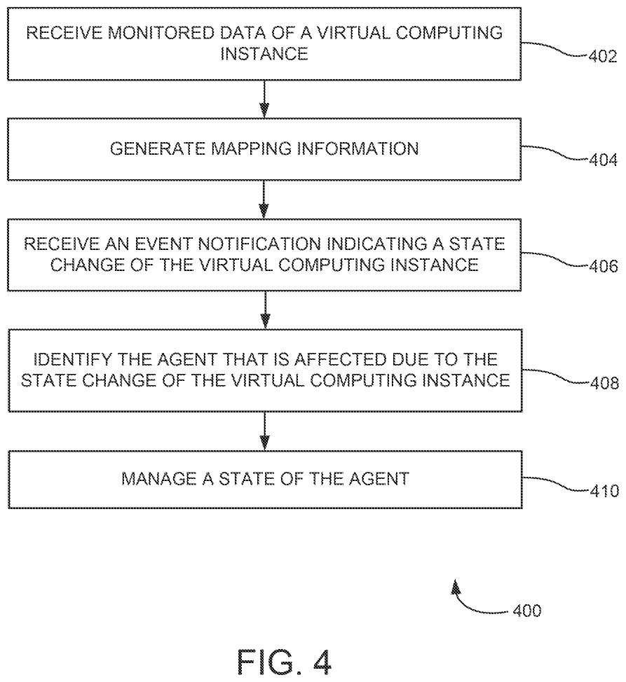

FIG. 4 is a flow diagram illustrating an example method 400 for managing a state of an agent based on a state change of a virtual computing instance. Example method 400 depicted in FIG. 4 represents generalized illustrations, and other processes may be added, or existing processes may be removed, modified, or rearranged without departing from the scope and spirit of the present application. In addition, method 400 may represent instructions stored on a computer-readable storage medium that, when executed, may cause a processor to respond, to perform actions, to change states, and/or to make decisions. Alternatively, method 400 may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but the flow chart illustrates functional information to design/fabricate circuits, generate computer-readable instructions, or use a combination of hardware and computer-readable instructions to perform the illustrated processes.

At 402, monitored data of a virtual computing instance deployed in a data center may be received from an agent running in a virtual computing instance. In an example, the monitored data may include an identifier of the virtual computing instance. For example, the virtual computing instance may include one of a virtual machine and a container executing on a host in the data center.

At 404, mapping information that associates the identifier of the virtual computing instance with an identifier of the agent may be generated. At 406, an event notification indicating a state change of the virtual computing instance may be received from an infrastructure management component residing in the data center. In an example, the event notification may be received from the infrastructure management component using a publish-subscribe mechanism. Further, the received event notification may indicate a change in state for the virtual computing instance from a powered-off state to a powered-on state, from a powered-on state to a powered-off state, or the virtual computing instance being deleted/terminated from the data center.

In response to receiving the event notification, at 408, the agent that is affected due to the state change of the virtual computing instance may be identified based on the mapping information. At 410, a state of the agent may be managed based on the state change of the virtual computing instance.

In an example, when the state change indicates that the virtual computing instance is powered-off, managing the state of the agent may include determining a cause of a failure to receive the monitored data from the agent is due to the virtual computing instance being powered-off in the data center. Further, the state of the agent may be updated to indicate that the virtual computing instance is powered-off.

In another example, when the state change indicates that the virtual computing instance is deleted, managing the state of the agent may include determining a cause of a failure to receive the monitored data from the agent is due to the virtual computing instance being deleted from the data center. Further, the state of the agent may be updated to indicate that the virtual computing instance is deleted.

In yet another example, when the state change indicates that the virtual computing instance is powered-on, managing the state of the agent may include determining that the monitored data received from the agent is due to the virtual computing instance being powered-on in the data center. Further, the state of the agent may be updated to indicate that the virtual computing instance is active.

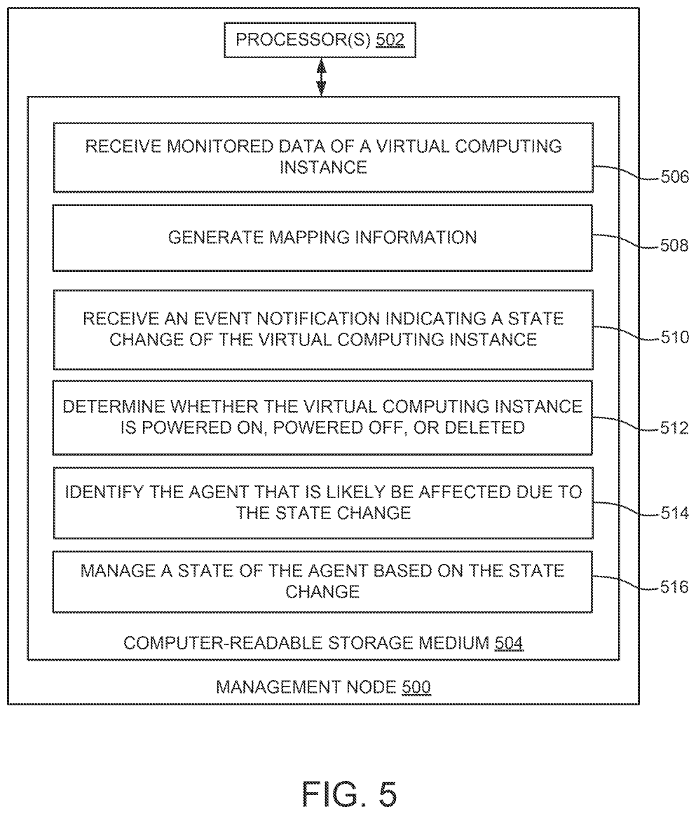

FIG. 5 is a block diagram of an example management node 500 including non-transitory computer-readable storage medium 504 storing instructions to manage a state of an agent based on a state change of a virtual computing instance. Management node 500 may include a processor 502 and computer-readable storage medium 504 communicatively coupled through a system bus. Processor 502 may be any type of central processing unit (CPU), microprocessor, or processing logic that interprets and executes computer-readable instructions stored in computer-readable storage medium 504. Computer-readable storage medium 504 may be a random-access memory (RAM) or another type of dynamic storage device that may store information and computer-readable instructions that may be executed by processor 502. For example, computer-readable storage medium 504 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 504 may be a non-transitory computer-readable medium. In an example, computer-readable storage medium 504 may be remote but accessible to management node 500.

Computer-readable storage medium 504 may store instructions 506, 508, 510, 512, 514, and 516. Instructions 506 may be executed by processor 502 to receive monitored data of a virtual computing instance from an agent running in the virtual computing instance. In an example, the monitored data may include an identifier of the virtual computing instance. For example, the virtual computing instance may include one of a virtual machine and a container executing on a host in the data center.

Instructions 508 may be executed by processor 502 to generate mapping information that associates the identifier of the virtual computing instance with an identifier of the agent. Instructions 510 may be executed by processor 502 to receive an event notification indicating a state change of the virtual computing instance from an infrastructure management component in the data center. In an example, instructions 510 to receive the event notification indicating the state change of the virtual computing instance may include instructions to receive the event notification from the infrastructure management component using a publish-subscribe mechanism, in which the management node subscribes to the event notification published by the infrastructure management component.

Further, instructions 512 may be executed by processor 502 to determine whether the virtual computing instance is powered-on, powered-off, or deleted based on the received event. In response to determining that the virtual computing instance is powered-on, powered-off, or deleted, instructions 514 may be executed by processor 502 to identify the agent that is likely be affected due to the state change based on the mapping information.

Instructions 516 may be executed by processor 502 to manage a state of the agent based on the state change. In an example, in response to determining that the virtual computing instance is powered-off, instructions 516 to manage the state of the agent may include instructions to determining a cause of a failure to receive the monitored data from the agent is due to the virtual computing instance being powered-off in the data center and update the state of the agent to inactive to disable monitoring of the virtual computing instance until virtual computing instance being powered-on.

In another example, in response to determining that the virtual computing instance is deleted, instructions 516 to manage the state of the agent may include instructions to determine a cause of a failure to receive the monitored data from the agent is due to the virtual computing instance being deleted from the data center and update the state of the agent to inactive to disable monitoring of the virtual computing instance.

In yet another example, in response to determining that the virtual computing instance is powered-on, instructions 516 to manage the state of the agent may include instructions to determine that the monitored data received from the agent is due to the virtual computing instance being powered-on in the data center and update the state of the agent to active to enable monitoring of the virtual computing instance.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not be meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A management node comprising:
a storage device to store mapping information associating an identifier of a virtual computing instance deployed in a data center with an identifier of an agent that runs in the virtual computing instance;
a processor communicatively coupled to the storage device;
memory coupled to the processor, wherein the memory comprises an agent management module to:
receive an event notification indicating a state change of the virtual computing instance from an infrastructure management component residing in the data center, the event notification comprising the identifier of the virtual computing instance;
in response to receiving the event notification, determine the agent that is likely to affect due to the state change of the virtual computing instance based on mapping information and the identifier of the virtual computing instance; and
manage a state of the agent based on the state change of the virtual computing instance.

2. The management node of claim 1, wherein the agent management module is to:
receive, from the agent running in the virtual computing instance, monitored data of the virtual computing instance deployed in the data center, the monitored data comprising the identifier of the virtual computing instance;
generating mapping information that associates the identifier of the virtual computing instance with the identifier of the agent; and
store the mapping information in the storage device.

3. The management node of claim 1, wherein the agent management module is to:
when the state change indicates that the virtual computing instance is powered-off, determine a cause of a failure to receive monitored data from the agent is due to the virtual computing instance being powered-off in the data center; and
update the state of the agent to indicate that the virtual computing instance is powered-off.

4. The management node of claim 1, wherein the agent management module is to:
when the state change indicates that the virtual computing instance is deleted, determine a cause of a failure to receive monitored data from the agent is due to the virtual computing instance being deleted from the data center; and
update the state of the agent to indicate that the virtual computing instance is deleted.

5. The management node of claim 1, wherein the agent management module is to:
receive the event notification from the infrastructure management component using a publish-subscribe mechanism, wherein the publish-subscribe mechanism is to enable the infrastructure management component to publish the event notification indicating the state change and enable the agent management module to subscribe to the event notification published by the infrastructure management component.

6. The management node of claim 1, wherein the state change of the virtual computing instance comprises a change in state for the virtual computing instance from a powered-off state to a powered-on state, from a powered-on state to a powered-off state, or the virtual computing instance being deleted/terminated from the data center.

7. The management node of claim 1, wherein the virtual computing instance is a virtual machine (VM) executing on a host in the data center.

8. The management node of claim 1, wherein the virtual computing instance is a container executing on a host in the data center.

9. A computer-implemented method comprising:
receiving, from an agent running in a virtual computing instance, monitored data of the virtual computing instance deployed in a data center, the monitored data comprising an identifier of the virtual computing instance;
generating mapping information that associates the identifier of the virtual computing instance with an identifier of the agent;
receiving an event notification indicating a state change of the virtual computing instance from an infrastructure management component residing in the data center;
in response to receiving the event notification, identifying the agent that is affected due to the state change of the virtual computing instance based on the mapping information; and
managing a state of the agent based on the state change of the virtual computing instance.

10. The method of claim 9, wherein managing the state of the agent comprises:
when the state change indicates that the virtual computing instance is powered-off, determining a cause of a failure to receive the monitored data from the agent is due to the virtual computing instance being powered-off in the data center; and
updating the state of the agent to indicate that the virtual computing instance is powered-off.

11. The method of claim 9, wherein managing the state of the agent comprises:
when the state change indicates that the virtual computing instance is deleted, determining a cause of a failure to receive the monitored data from the agent is due to the virtual computing instance being deleted from the data center; and
updating the state of the agent to indicate that the virtual computing instance is deleted.

12. The method of claim 9, wherein receiving the event notification indicating the state change of the virtual computing instance comprises:
receiving the event notification from the infrastructure management component using a publish-subscribe mechanism.

13. The method of claim 9, wherein receiving the event notification indicating the state change of the virtual computing instance comprises:
receiving the event notification indicating a change in state for the virtual computing instance from a powered-off state to a powered-on state, from a powered-on state to a powered-off state, or the virtual computing instance being deleted/terminated from the data center.

14. The method of claim 9, wherein the virtual computing instance comprises one of a virtual machine and a container executing on a host in the data center.

15. A non-transitory computer-readable storage medium storing instructions executable by a processor of a management node to:
receive monitored data of a virtual computing instance from an agent running in the virtual computing instance, the monitored data comprising an identifier of the virtual computing instance;
generate mapping information that associates the identifier of the virtual computing instance with an identifier of the agent;
receive an event notification indicating a state change of the virtual computing instance from an infrastructure management component in the data center;
determine whether the virtual computing instance is powered-on, powered-off, or deleted based on the received event;
in response to determining that the virtual computing instance is powered-on, powered-off, or deleted, identify the agent that is likely be affected due to the state change based on the mapping information; and
manage a state of the agent based on the state change.

16. The non-transitory computer-readable storage medium of claim 15, wherein instructions to manage the state of the agent comprise instructions to:
in response to determining that the virtual computing instance is powered-off, determining a cause of a failure to receive the monitored data from the agent is due to the virtual computing instance being powered-off in the data center; and
update the state of the agent to inactive to disable monitoring of the virtual computing instance.

17. The non-transitory computer-readable storage medium of claim 15, wherein instructions to manage the state of the agent comprise instructions to:
in response to determining that the virtual computing instance is deleted, determine a cause of a failure to receive the monitored data from the agent is due to the virtual computing instance being deleted from the data center; and
update the state of the agent to inactive to disable monitoring of the virtual computing instance.

18. The non-transitory computer-readable storage medium of claim 15, wherein instructions to manage the state of the agent comprise instructions to:
in response to determining that the virtual computing instance is powered-on, determine that the monitored data received from the agent is due to the virtual computing instance being powered-on in the data center; and
update the state of the agent to active to enable monitoring of the virtual computing instance.

19. The non-transitory computer-readable storage medium of claim 15, wherein instructions to receive the event notification indicating the state change of the virtual computing instance comprise instructions to:
receive the event notification from the infrastructure management component using a publish-subscribe mechanism, in which the management node subscribes to the event notification published by the infrastructure management component.

20. The non-transitory computer-readable storage medium of claim 15, wherein the virtual computing instance comprises one of a virtual machine and a container executing on a host in the data center.
